(19) United States
(12) Patent Application Publication
(10) Pub. No.: US 2005/0121530 A1
(43) Pub. Date: Jun. 9, 2005

(54) System defined as thermoister for monitoring, controlling and adjusting a sleeper's environmental conditions of the space above entire bed surface

(76) Inventor: Thomas Song, Leesburg, VA (US)

Correspondence Address: THOMAS SONG, 42827 SPINKS FERRY RD, LEESBURG, VA, 20176, US

(21) Appl. No.: 10/727,849

(22) Filed: Dec. 4, 2003

(51) Int. Cl. B01F 3/02; G05D 21/00

(52) U.S. Cl. 236/44 C; 236/44 R

(57) ABSTRACT

Method and apparatus for monitoring, controlling and adjusting sleeper's environmental conditions of the space above entire bed surface by partially sealing and insulating the space above the entire bed surface; monitoring, controlling and adjusting temperature, quality, oxygen level and moisture level of the air within the partially sealed and insulated space according combinational factors of the sleeper's preferences, the sleeper's physiological conditions, heat transfer rate between sleeper's body and ambient air, the internal conditions and external conditions of the partially sealed and insulated space. In particular, a system uses a three-dimensional structure to partially seal and insulate an adequate amount of space above entire bed surface; uses physiological state sensors, thermometers, thermostats, heating device, cooling device, humidistat (hygrostat), humidifier and dehumidifier, oxygen sensor, oxygen supply device, air filtration device to monitor, control and adjust the temperature, moisture level, oxygen level and quality of the air inside the partially sealed and insulated space.

### FIELD OF THE INVENTION

The present invention relates sleeper's environment control of the space above entire bed surface for general population. The present invention monitors, controls and adjusts sleeper's personal environment according to combinational factors of the sleeper's preferences, the sleeper's physiological conditions, heat transfer rate between sleeper's body and ambient air, the internal conditions and/or external conditions of the partially sealed and insulated space.

### INVENTION BACKGROUND

Sleep well has been a challenge for many. In homes without air conditioning or heating system, hot nights and cold nights make a comfortable-night of sleep hard to obtain. In homes with air conditioning and heating system, environment for a comfortable-night of sleep improved tremendously during hot and cold nights. However, there are still several problems that prohibit a comfortable-night of sleep. Following are major problems investor's experienced and of which inspired this invention.
When sleeping, sleeper relies on fabric coverings to keep warm. Often, sleeper would flip and turn to cause fabric coverings partially or fully off the sleeper's body. The exposure may cause the sleeper to feel cold, weakening one's immune system, or possibly get sick.
For children, they tend flip and turn more often and do not know how to fix their covering even they feel cold. Typical parents may need to wake up several times to fix the fabric coverings to keep children covered properly during the entire night.
Over the entire night, typical sleeper needs less covering first half of the night and more covering during second part of the night during the change of sleeper's physiological conditions.
For people with problems such as enlarged adenoids or tonsils, etc. existing in-house air conditioning, heating system and humidifier helps to make them to sleep better. However, they are difficult to control as a system in whole and the most preferable sleeping environment is difficult to obtain and not cost efficient.

Research found many references relate to environmental control for numerous types of applications and previous inventions of sleeper's environmental control only solve some problems for general population. For instance, in U.S. Pat. No. 6,503,751, Hugh discloses a controlled-atmosphere incubator that completely seals a given amount of space and provides control on temperature, moisture, and air content mixture for laboratory environment. In U.S. Pat. No. 6,511,414, Hamsund invented an infant incubator that provides necessary environmental control for premature or weakly infants in the medical field. In U.S. Pat. No. 6,571,690, Hsu teaches a method of yogurt making in an environmentally controlled space at home for making yogurt. In the field of sleeping environment control for general population, U.S. Pat. No. 6,425,527, Smole teaches a method of drawing excessive heat in the space between bed surface and the fabric covering; In U.S. Pat. No. 5,299,428 by Kawaguri, U.S. Pat. No. 6,006,524 by Park and U.S. Pat. No. 6,336,237 by Schmid, they teach different methods of environmental control according to the conditions of the air in the bed or on immediate surface of the bed. These and other previous inventions only solve some of the problems associated with sleeping environment control. They would not solve all the problems listed above. The present invention is intended to solve all these problems, enhancing sleeping environment so sleeper may not need fabric covering as primary way to keep warm and other problems that may prevent a comfortable-night of sleep for general population.

### SUMMARY OF THE INVENTION

The present invention relates to a system defined as Thermoister for monitoring, controlling and adjusting sleeper's environmental conditions of the space above bed surface by partially sealing and insulating the space above bed surface; monitoring, controlling and adjusting temperature, quality, oxygen level and moisture level of the air within the partially sealed and insulated space according the sleeper's preferences, the sleeper's physiological conditions, heat transfer rate between sleeper's body and ambient air, the internal conditions and/or external conditions of the partially sealed and insulated space. This is accomplished by making a three-dimensional structure to partially seal and insulate the space above bed surface. The three-dimensional structure is partially sealed to allow adequate nature air exchange in order to maintain necessary oxygen level, especially in situation when one or more devices fail. Venting pipes are installed on all sides of the three-dimensional structure to provide even air exchange inside of the three-dimensional structure, and air exchange between inside and outside of the three-dimensional structure. The venting pipes are connected to air conditioning devices that are electric fans, a heating element, a cooling element, a humidifier, a dehumidifier, and an oxygen supply device, air intake and outtake device and/or air filtration device. The electric fans are responsible to propel the air in and out the venting pipes. The heating device is responsible to heat the air in the venting pipe. The cooling device is responsible to cool the air in the venting pipe. Humidifier is responsible to moisturize the air in the venting pipe. Dehumidifier is responsible to extract moisture out the air in the venting pipe. Oxygen supply device is responsible to release adequate amount of oxygen to the air in the venting pipe. Air filtration device is responsible to filter dust, microorganisms out of the air in the venting pipe. The air intake and outtake device draws air from outside of the venting pipes into the venting pipes or draws air from inside of the venting pipes to outside of the venting pipes. The electric fans, heating device, cooling device, humidifier, dehumidifier, and/or oxygen supply device are connected to and controlled by the control unit. The control unit receives information from personal preference control and data storage device, the sensors and determines which connected devices to turn on or off, and at what performance level. The sensors that reports information to the control unit wirelessly or via wire include following:
Temperature sensor outside of the three-dimensional structure for reading the temperature of outside air.
Temperature sensor inside of the three-dimensional structure for reading the temperature of inside air.
Physiological condition sensors attached on sleeper's body or wear by sleeper for reading sleeper's physiological conditional information such as sleeper's body temperature, sleeper's sleep state and other physiological information that the control unit can use to enhance the sleeper's environmental conditions.
Heat exchange rate between the sleeper and the ambient environment
Hydrometer outside of the three-dimensional structure for reading the moisture level of outside air.
Hydrometer inside of the three-dimensional structure for reading the moisture level of inside air.
Oxygen level sensor outside of the three-dimensional structure for reading the oxygen level of outside air.
Oxygen level sensor inside of the three-dimensional structure for reading the oxygen level of inside air.

A personal preference control and data storage device stores sleeper's personal information, personal preferred settings, factory default settings and report the information to a control unit. Each personal preference data storage device has a unique identifier and is capable to communicate to all control units. The control unit can record the unique identifier of the personal preference control and data storage device and use the information on the registered personal preference data storage device or settings on itself to control air conditioning devices. This communication and control mechanism between the personal preference control and data storage device and the control units allow sleepers to easily use one's own preferred settings when sleep on difference beds.

To enhance operation of Thermoister, devices can be easily updated, serviced or replaced. Automation can be used to turn on and turn off Thermoister according to sleeper's preferences, and the movements of parts of the Thermoister can be motorized to provide convenience and luxury to sleeper.

### SUMMARY OF THE DRAWING

FIG. 1 is a conceptual overview of Thermoister.

FIG. 2 is some of the possible configurations for the three-dimensional structure.

FIG. 3 is a detail conceptual view of the air conditioning unit.

FIG. 4 is an example of ways that the three-dimensional structure can be supported and folded.

### DETAIL DESCRIPTION OF THE INVENTION

The present invention is a system that monitors, controls and adjusts the sleeper's environmental condition of the space above entire bed surface. It should be understood that variations of shapes and configurations utilize the concept of Thermoister are still within the scope of this invention.

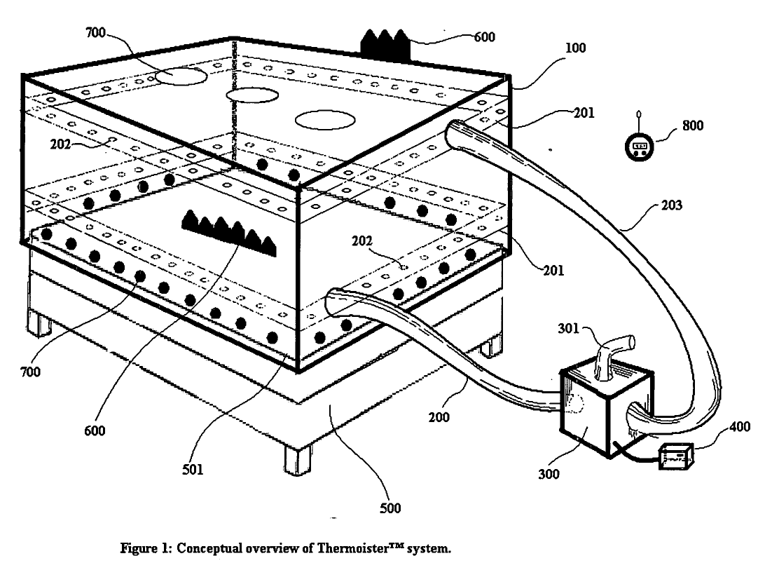

FIG. 1 is a conceptual overview of the Thermoister. This figure just illustrates the concept of Thermoister because there're numerous shapes and configurations can be used to implement Thermoister. The three-dimensional structure 100 encloses the space above the bed surface 501. The length and width of the three-dimensional structure 100 are just a little bigger than the dimension of the bed 500. The height of the three-dimensional structure 100 can vary. Typically it would be anywhere from floor to the ceiling to allow sleeper to convenient access the bed.

Venting pipes 201 with many small holes 202 is only visible from inside of the three-dimensional structure 100. Venting pipes 201 are typically on all four sides or on ceiling of the three-dimensional structure 100. Venting pipes 201 is responsible to uniformly draw air from inside of the three-dimensional structure 100 to venting pipe 200 or venting pipe 300 with respect to the direction of the flowing air and return the air back into the three-dimensional structure 100. The direction of airflow in venting pipes 200, 201, 202 and 203 is not fixed. Air can flow from either direction according to control signals from control unit 400. The purpose is to allow air to flow from one end to another according to the mode of operation. For example, cool air would come out from upper venting pipe 201 on the three-dimensional structure 100 because cold air is heavier than warm air. Therefore, the air would fall down.

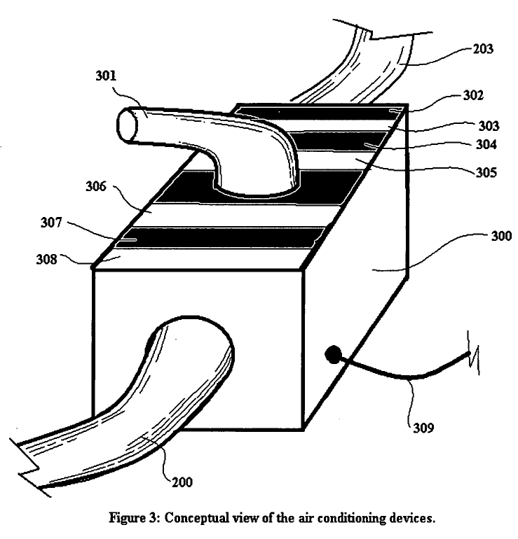

Venting pipes 200 and 203 connected to venting pipes 201 and are also connected to air conditioning unit 300. Air in venting pipe 200 or 203 flows in to the air conditioning unit 300, gets conditioned by the activated conditioning devices and comes out from the other end back into the three-dimensional structure. If the air outside of the three-dimensional structure can be used to condition the air in the three-dimensional structure, outside air can be drawn in or the air in the three-dimensional structure can be drawn out to achieve the desired condition in the three-dimensional structure. This is a more efficient way than using the heating, cooling, humidifier, dehumidifier and/or oxygen supply device. Air conditioning unit 300, which is controlled by control unit 400, will be illustrated in detail in FIG. 3.

To adequately seal and insulates the space above the entire bed surface. 501, the three-dimensional structure 100 cannot be complete sealed. The reason is that sufficient nature airflow is needed when the system is not powered on, or when one or more component fails. The adjustable venting holes 700 serve this purpose. The adjustable venting holes 700 can be different sizes and located at various location of the three-dimensional structure 100. The adjustable venting holes 700 have minimum required size for different size of bed. For example, for king, full mattress, the three-dimensional structure 100 would have more holes or bigger holes venting 700 for king size mattress verse full size mattress. If a sleeper prefers additional natural airflow, the venting holes 700 are adjustable to satisfy the sleeper.

Sensors 600 are installed at various location of inside, outside of the three-dimensional structure 100 or on the three-dimensional structure 100 according to its function. For example, if a sensor is for measuring temperature of air outside of the three-dimensional structure 100, the sensor is installed somewhere at outside of the three-dimensional structure 100. Sensors 600 are a collection of sensors that detect and measure the sleeper's physiological conditions, heat transfer rate between sleeper's body and ambient air, the presence of sleeper in bed, the internal and external temperature, moisture level and/or oxygen level of the three-dimensional structure 100. To detect a sleeper's physiological conditions, many things can be measured. For instance, the sleeper's oxygen content, respiratory rate, heart rate, sleep state can be measured. Combination of these measurements can be used to determine the need for the sleeper. For the same reason, the heat transfer rate between sleeper's body and ambient air is useful to help making the decision as to what temperature is best for the sleeper at different heat transfer rates. The functions of temperature sensor, moisture level sensor and oxygen sensors are easy to understand. They measure temperature levels; moisture levels and oxygen levels bother inside and outside of the three-dimensional structure 100. The measured data and sleeper's personal preferences are analyzed to determine how to condition the air in the three-dimensional structure. Sensors 600 communicate the detected or measured information to control unit 400. In addition to the measurements associate with air, there is sensor that detects the presence of sleeper in bed. This information allows sleeper to have an option to turn on and turn off the Thermoister automatically when the sleeper get in or out the bed. All communication from sensors 600 to control unit 400 can be done via wire or wirelessly.

Personal preference control and data storing device 800 allows a sleeper to select, modify and store one's personal preference on sleeping environmental control. Personal preference control and data storing device 800 has following function, use and features:
Have unique serial number or identification number and a mechanism to allow it to register itself to any control unit 400 by a simple user interface. Its function is to allow travelers to use one's own personal preference control and data storing device 800 to control different Thermoister at home, in hotels and other places.
Store factory default preferences. This is to provide convenience to sleepers and new users. The default preferences are a list of most common used settings by each age group on temperature, moisture level and/or oxygen level. These levels settings can be constant or variant as function of time. For some people, they may like different settings at different times during the night. Another factory default preference setting is a list of auto turn on and turn off schemes. These schemes would allow a sleeper to choose when and how the Thermoister would turn on or turn off automatically. To make Thermoister more convenient to sleeper, a list of factory default preference settings for alerting the sleeper when one or more devices fail is implemented. Once the sleeper selected a setting, the settings can be modified as the sleeper desires and can be saved as this sleeper's personal preference setting and is associated with an identification string that can be a person's name, location name, etc.
Store preference settings for one or more people and allow each sleeper to select and modify one's own settings. This also allow a person have multiple sets of settings. For example, one may want to have two sets. One for home and one for traveling. For the home one, Thermoister should not auto turn on and turn off immediate because the sleeper spending time with children before going to sleep. On the road, the sleeper goes to sleep immediately after getting in bed. Therefore, the Thermoister can auto turn on and turn off when the sleeper is detected.
For each user, the preferences settings include temperature, moisture level, oxygen level and/or auto turn on and turn off scheme.
The temperature, moisture level, oxygen level can be programmed to stay constant throughout the entire sleeping period or vary as function of time. This is useful because typically, sleeper prefers higher temperature in the second half of the night verses the first half of the night.
Auto turn on and turn off option can be enabled or disabled. If it is enabled, the sleeper can select one's own turn on and turn off scheme, customize it and save it. For example, one sleep may only want the Thermoister to self-activate if it's from 9:00 pm to 6:00 am and 5 minutes after the sleeper got in bed.
Programmable to allow device update, new feature and function implementation. The feature is particularly useful for product updates or enhancements.
Lighting to allow sleeper to operate personal preference control and data storing device 800 in darkness.
User interface to a sleeper to complete the tasks specified in this invention.
To make it convenient for sleeper, personal preference control and data storing device 800 can comprise a clock, alarm clock and the user can carry it around easily. One way to do it is to make personal preference control and data storing device 800 like a wristwatch so user can easily carry it anywhere they go.

Control unit 400 communicates with all personal preference control and data storing device 800 and can register one of any personal preference control and data storing device 800. Control unit 400 includes a duplicated device of personal preference control and data storing device 800. If no personal preference control and data storing device 800 is registered, it allows a sleeper to set personal preferences on the control unit. Control Unit 400 analyzes the personal preferred settings and information received from sensors 600 to determine the best method to obtain the desired condition in the three-dimensional structure 100. With the chosen method, Control unit 400 may only turn on the heating unit, cooling unit and/or humidifier depending on the situation. If the sleeper enabled the auto turn on and turn off feature, control unit 400 would turn on or turn off the entire Thermoister system automatically depending the options chosen by sleeper. Otherwise, the sleeper will have to turn it on and off manually. Control unit 400 is programmable and connected to computer network or Internet for device update, new feature installation, new function implementation and/or central management and maintenance. These feature is particular useful in commercial environment such as hotels and dormitories. Thermoister has a self-test feature. The self-test feature of control unit 400 would be able to report any maintenance need or device failure and alert sleeper according to sleeper's selected options.

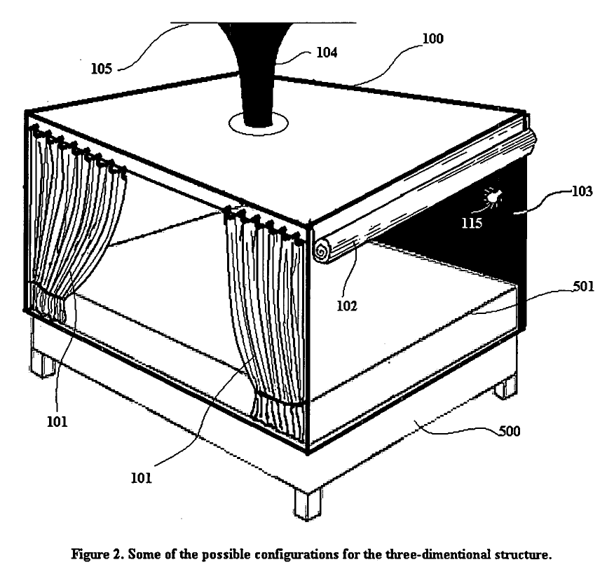

FIG. 2 illustrates some optional configurations and operations of the three-dimensional structure 100. This figure shows that one way to support the three-dimensional structure 100 is to attach it to ceiling 105 by the supporting element 104. To allow people lean against the wall for support, the wall of the three-dimensional structure 100 can be firm and solid as shown by wall piece 103. To allow easy access to the bed for the sleeper, the walls can be made with soft material allow horizontal folding as shown by folding piece 101. Another option shown by wall piece 102 that allows the wall piece to folder vertically up. To allow emergency escapes, the walls of the three-dimensional structure can be easily broken through. The illustrative drawing in FIG. 2 is just an example. Other methods and configuration can be used to accomplish the same function. To allow sleeper to see inside the three-dimensional structure 100 clearly, lighting device 115 can be installed somewhere in the three-dimensional structure 100 to provide adjustable lighting intensity. To bring luxury and convenience to sleeper, motorized device can be use to do the folding of the wall pieces.

FIG. 3 is a conceptual view of the air conditioning unit 300. Physical configuration can vary. Air comes in from one end of the venting device 200 or 203, and come out from the other end. The air in the conditioning unit 300 get conditioned by heating device 302, humidifier 303, oxygen supply device 304, cooling device 306, dehumidifier 307, air intake and outtake device 301. The functions of the air conditioning device are easy to understand except air intake and outtake device 301. Air intake and outtake device is capable of taking air from outside into the air conditioning unit 300 or taking air from inside of the air conditioning unit 300 to outside of the air conditioning unit 300. The function of air intake and outtake device 301 is to condition the air in the three-dimensional structure 100 with air from outside of the three-dimensional structure 100 as show in FIG. 1. This function is accomplished by taking advantage of the differences of the attributes of the air inside and outside of the three-dimensional structure 100. Control unit 400 shown in FIG. 1 controls air-conditioning devices 300.

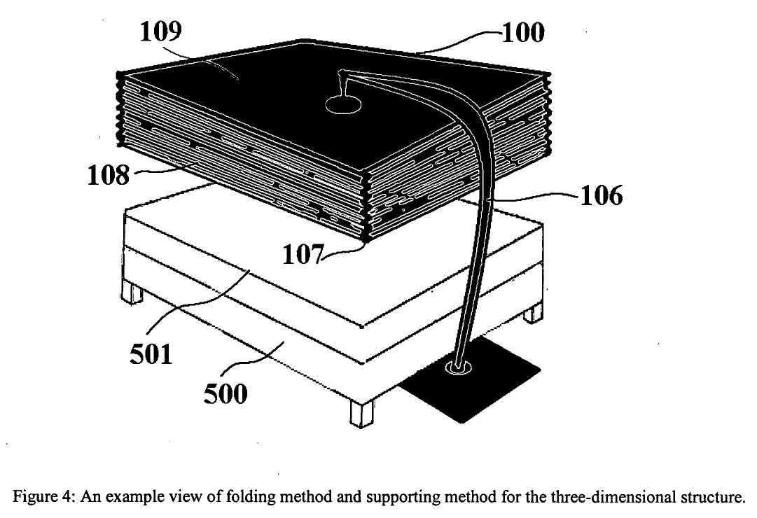

FIG. 4 illustrates one optional movement of the three-dimensional structure 100. Besides the illustration in FIG. 2 that the walls of the three-dimensional structure 100 can fold. FIG. 4 shows an example that the entire three-dimensional structure can fold horizontally and/or vertically. In this case, the three-dimensional structure is supported by its own footing 106. All walls 108 and corner pieces 107 of the three-dimensional structure 100 are made of soft materials to allow the three-dimensional structure to fold up as shown. To bring luxury and convenience to sleeper, motorized device can be use to do the folding of the three-dimensional structure.

1. A system defined as Thermoister that comprises:
a. A three-dimensional structure that adequately seals and insulates space above an entire bed surface up to an adequate height.
b. A venting device that takes in air inside said three-dimensional structure from one end of said venting device and returns the air back into said three-dimensional structure on other end of said venting device.
c. Air conditioning devices that can modify temperature, moisture level, oxygen level, and/or air quality of the air in said venting system.
d. Sensors that detect physiological conditions of sleeper, internal conditions and external conditions of said three-dimensional structure, heat transfer rate between sleeper's body and ambient air in said three-dimensional structure, and/or presence of sleeper in bed, and report detected information.
e. A personal preference control and data storing device that allows a sleeper to set and use one's personal preference on temperature, moisture level, oxygen level and/or auto turn on and turn off scheme, and report the preference setting information.
f. A control unit that receives information from said sensors and said personal preference control and data storing device; And use combinational factors of the information received to control said air conditioning devices to produce desired air quality, temperature, moisture level and/or oxygen level of the air inside said venting device; And/or use the selected auto turn on and turn off scheme to activate and deactivate said Thermoister.

2. A system according to claim 1, wherein said three-dimensional structure comprises:
a. Lighting device that provides light in said three-dimensional structure.
b. Any shape, form and/or design of three-dimensional structure as long as it serve the function similar or same as Thermoister.
c. Support footing that utilizes the footing of existing footing of the bed, the ceiling of the room or its own of any shape, form and/or design for support of said three-dimensional structure.
d. Walls and ceiling that are made solid material that do not fold or bend, and/or are made of soft materials that fold vertically or horizontally.
e. Means to fold said three-dimensional structure manually or via automation.
f. Means to fold said walls and ceiling of said three-dimensional structure manually or via automation.

3. A system according to claim 1, wherein said Air conditioning devices comprises:
a. A filtration device that filters the air in said venting device and has means to report working condition of said filtration device to said control unit.
b. A cooling device that cools the air in said venting device and has means to report working condition of said cooling device to said control unit.
c. A heating device that warms the air in said venting device and has means to report working condition of said heating device to said control unit.
d. A humidifier device that moisturizes the air in said venting device and has means to report working condition of said humidifier device to said control unit.
e. A dehumidifier device that drains moisture out the air in said venting device and has means to report working condition of said dehumidifier device to said control unit.
f. An oxygen supply device that releases oxygen into said venting device and has means to report working condition of said oxygen supply device to said control unit.
g. An air-propelling device to circulate the air in said venting device and has means to report working condition of said air propelling device to said control unit.
h. An air intake and outtake device that draws air from outside of said venting device into said venting devices or draws air from inside of said venting device to outside of said venting device, and has means to report working condition of said air intake and outtake device to said control unit.

4. System according to claim 1, wherein said sensors comprises:
a. A sensor positioned inside said three-dimensional structure to detect temperature and report the detected temperature level information to said control unit.
b. A sensor positioned outside said three-dimensional structure to detect temperature and report the detected temperature level information to said control unit.
c. Sensors positioned on the sleeper's body to detect physiological condition information and report the physiological condition information to said control unit.
d. A sensor position in said three-dimensional structure to detect moisture level and report detected moisture level information to said control unit.
e. A sensor position outside said three-dimensional structure to detect moisture level and report the moisture level information to said control unit.
f. A sensor position in said three-dimensional structure to detect oxygen level and report the oxygen level information to said control unit.
g. A sensor position outside said three-dimensional structure to detect oxygen level and report the oxygen level information to said control unit.
h. A sensor position in said three-dimensional structure to detect heat transfer rate from body to ambient air in said three-dimensional structure and report the heat transfer rate information to said control unit.
i. A sensor for detecting the presence of sleeper in bed and report the detected information to said control unit.

5. A system according to claim 1, wherein said personal preference control and data storing device comprises:
a. Data table type that comprise following fields:
i. Array of temperature settings as function of time.
ii. Array of moisture level settings as function of time.
iii. Array of oxygen level settings as function of time.
iv. Array of time intervals correspond to said array of temperature settings, said array of moisture level settings and/or said array of oxygen level settings.
b. Factory default preference list comprises a list of said data tables ordered by age groups.
c. Factory default Auto turn-on and turn-off schemes comprise a list of auto turn on and turn off schemes that allow sleeper to choose for turning on and off Thermoister automatically.
d. Factory default alert options list to alert sleeper when one or more component of Thermoister fails.
e. Personal preference information that is a personal preference table that includes an identification name, one said data table, one said Auto turn on and turn off scheme and one said alert option.
f. Means to store multiple said personal preference tables for one or more sleepers.
g. Means to select a said personal preference table and modify said identification name, the fields in said data table, the fields of said auto turn on and turn off scheme, of the selected personal preference table; and save the modified personal preference information.
h. Means to report the information of selected personal preference table to said control unit.
i. Illuminating device to allow sleeper to operate said personal preference control and data storing device in darkness.
j. A unique identification number or name.
k. Means to communicate to all control units and register its unique identification number to any control unit.
l. Means to attach said personal preference control and data storing device to sleeper.
m. Means to reprogram said personal preference and data storing device to add product updates, new functions and features.
n. Time telling device and an alarm clock.

6. A system according to claim 1, wherein said control unit comprises:
a. Means to receive information from said sensors and personal preference control and data storing device via wire and wirelessly.
b. Means to turn on and turn off Thermoister system manually.
c. Means to turn on and turn off Thermoister system automatically according to selected said auto turn-on and turn-off scheme.
d. Means to turn on and turn off each of the said cooling device, said heating device, said humidify device, said dehumidify device and said oxygen supply device, said air propelling device and said air intake control device independently.
e. Means to self-test all devices of said Thermoister and report irregularities of relevant device of Thermoister.
f. Means to alert sleeper when one or more components of Thermoister fails.
g. A duplicate device of said personal preference control and data storing device so sleeper can utilizes Thermoister without said control and data storing device.
h. Means to communicate to all said personal preference control and data-storing device.
i. Means to register a particular said personal preference control and data storing device
j. Means to use selected said personal preference information and information received from said sensors to control devices of Thermoister.
k. Means to reprogram said control unit to add product updates, new functions and features.
l. Means to connect to computer network to allow centralized management and maintenance.
